(19) United States
(12) Patent Application Publication
(10) Pub. No.: US 2011/0162928 A1
(43) Pub. Date: Jul. 7, 2011

(54) Super-Compressible Piston Shock Absorber

(76) Inventor: Kelce S. Wilson, Murphy, TX (US)

(21) Appl. No.: 12/651,860

(22) Filed: Jan. 4, 2010

(51) Int. Cl. F16F 9/02

(52) U.S. Cl. 188/322.19; 188/266

(57) ABSTRACT

Piston-in-cylinder type shock absorbers are disclosed that are compressible to less than half of their extended length, thereby eliminating the current need for automotive suspensions to accommodate unwieldy shock absorbers that, even when fully compressed, must be longer than the amount of permitted axial suspension travel at the shock absorber's connection point. Since the disclosed shock absorbers are super-compressible, they are also super-extendable, which is extendable beyond double their compressed length. In some embodiments, this super-compressibility and super-extendibility are rendered possible by the use of a rigidly interleaved, oppositely-oriented, axially-balanced, free-floating bank of gas-charged cylinders.

### TECHNICAL FIELD

The present invention relates to automobile suspension components, specifically, shock absorbers.

### BACKGROUND

Despite more than 100 years of engineering effort by experts around the world, intense competition among a myriad of companies attempting to produce a superior product, and also widely-ranging variations in design philosophy, automobiles still almost universally use an archaic, performance-limiting suspension component: a piston-in-cylinder shock absorber that, even when fully compressed, remains longer than half its extended length.

When examining the ground clearance of typical four wheel drive automobiles, which are often ostensibly designed for off-road use, a disturbing trend appears: Shock absorbers typically extend so low to the ground that they are in serious risk of sustaining severe damage by striking rocks when the automobile is taken on a challenging four-wheel-drive trail. Yet those same shock absorbers, that present such easily-noticeable ground clearance problems, will also often extend upward fairly high, to the uppermost parts of the automobile suspension. This often causes them to intrude into space that could be better used for other purposes, such as providing additional room in the engine bay or the passenger compartment. For many automobiles, shock absorbers require the greatest vertical clearance of all suspension components, thereby defining the minimum height that the automobile designed must dedicate to the suspension.

Why must automotive suspensions dedicate such an unprecedented amount of vertical clearance to shock absorbers? Because current automotive shock absorbers cannot be compressed by even half of their fully extended length.

The automotive suspension must thus accommodate a component that, even when in its fully compressed state, must be longer than the entire amount of permitted suspension travel at the connection point, as oriented along the shock absorber axis. In order to permit the large amount of suspension travel that is needed for typical off-road use, current shock absorbers must be rather long or else must be installed at performance-limiting angles. This requires the automotive suspension designers to use extremely widely-separated mounting points for shock absorbers: one that is high enough to potentially intrude into engine bays or adversely impact passenger room, and another that is low enough to risk striking rocks during off-road use.

Currently, the shock absorber is the only suspension component that requires such unprecedented vertical clearance accommodation, and therefore, it presents significant constraints on automotive suspension design.

Therefore, there exists abundant evidence of both a long-felt but unresolved need to relax the vertical clearance constraint, and also a failure of others to solve the problem that current piston shock absorbers are so unwieldy. Evidence for the unresolved need includes the use of lever-style suspensions, such as on the rear wheel of a motorcycle, with placement of shock absorbers placed toward the pivot point of the lever, and away from the end where the suspension deflection is the greatest, and also angled installations, which are visible on many pickup trucks with shock absorbers mounted relatively far inward on the rear axle. Although these arrangements can permit the suspension to deflect a wheel by an amount that is more than half the extended length of the shock absorber, because the lever and angle arrangement result in a greater force on the shock absorber, shock absorbers used in those installations must be constructed heavier to handle the greater force. Evidence of the failure of others to solve the afore-mentioned problem includes the continued production of four wheel drive automobiles, more than 100 years after the advent of the automobile, that share a nearly universal flaw: current shock absorbers limit ground clearance, thereby degrading off-road capability.

### BRIEF DESCRIPTION OF THE DRAWINGS

For a more complete understanding of the present invention, reference is now made to the following descriptions taken in conjunction with the accompanying drawings, in which:

FIG. 1 illustrates an embodiment of a super-compressible piston shock absorber in both extended and compressed states.

FIG. 2 illustrates a prior art piston shock absorber in both extended and compressed states.

FIG. 3 illustrates an embodiment of a super-compressible piston shock absorber comprising a rigidly interleaved, oppositely-oriented, axially-balanced, free-floating bank of gas-charged cylinders.

FIG. 4 illustrates an axial view of an embodiment of a super-compressible piston shock absorber combined with a coil spring.

### DETAILED DESCRIPTION OF THE INVENTION

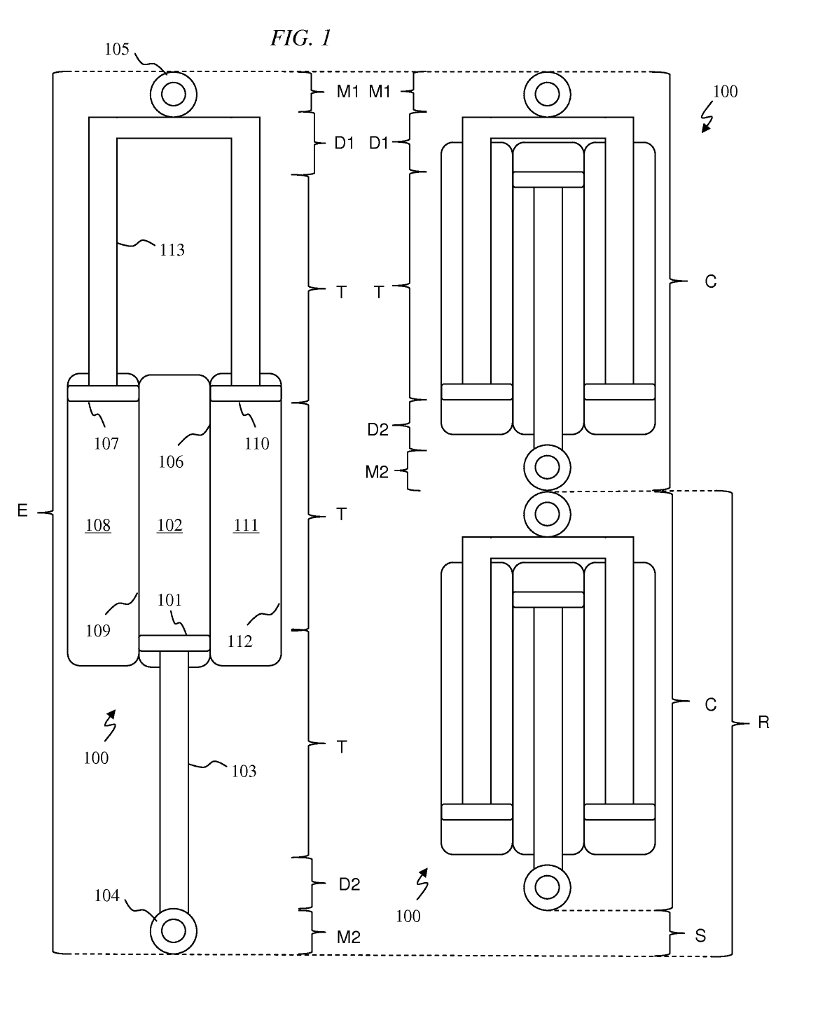

FIG. 1 illustrates an embodiment of a piston shock absorber 100 in both an extended state and a compressed state, showing that it is compressible beyond half of its extended length. Using E as the fully extended length, C as the fully compressed length, and R as the range of travel distance for the ends 101 and 102 of piston shock absorber 100 relative to each other, the illustration of FIG. 1 shows how it is possible for piston shock absorber 100 to be described with the following equations: E=C+R; C=E−R; E>2C; C<E/2; R>E/2; and R>C.

As used in the above equations, R is both the amount of compressibility and the amount of extendibility. Compressibility is the potential travel range, R, of the ends of a piston shock absorber toward each other, when the shock absorber starts in a fully extended state. Extendibility is the potential travel range, also R, of the ends of a piston shock absorber away from each other, when the shock absorber starts in a fully compressed state. As used herein, a piston shock absorber is the automotive-style shock absorber, having a piston which moves against resistance within the confining space of a cylinder. Simple blocks of potentially shock-absorbing material, for example compressible foam and friction pads at a hinge point, are not piston shock absorbers. For all piston shock absorbers described herein, whether new or prior art, compressibility is the same amount as extendibility, and is denoted in the equations as R.

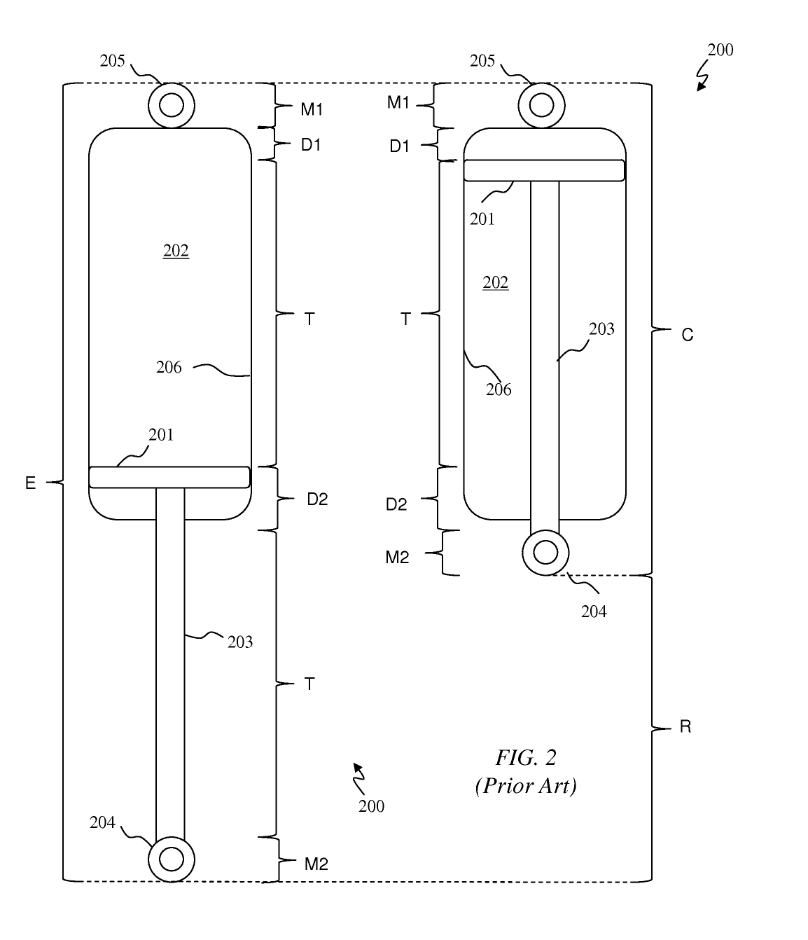

The first two of the above equations, E=C+R and C=E−R, are generic to all piston shock absorbers described herein, whether new or prior art. Because R is defined by R=E−C, the equation E=C+R is merely a statement that the extended length, E, equals the compressed length, C, plus the extendibility travel range, R. And the equation C=E−R is merely a statement that the compressed length, C, equals the extended length, E, minus the compressibility travel range, R. Derivation of the equations that uniquely describe piston shock absorber 100 (E>2C; C<E/2; R>E/2; and R>C) will be described in more detail following a description of the prior art, which is illustrated in FIG. 2. However, a preview of the advantages of piston shock absorber 100 will be provided first.

Examining the four equations that uniquely describe piston shock absorber 100, E>2C, indicates that E is more than double C. Thus, piston shock absorber 100 has an extended length, E, that is more than twice its compressed length, C. The next equation, C<E/2, indicates that C is less than half of E. Thus, piston shock absorber 100 has a compressed length, C, that is less than half of its extended length, E. Piston shock absorber 100 can thus be described as both super-compressible and super-extendable.

R>E/2 indicates that piston shock absorber 100 is compressible beyond half its extended length. As used herein, super-compressible denotes compressible beyond half the extended length. It is a significant advantage that piston shock absorber 100 is compressible by an amount that exceeds half its extended length, because this newly-available shock absorber feature reduces the required minimum vertical clearance dimension that imposes such a stringent constraint on automobile suspension design. Suspension designs are now available that use piston shock absorbers having a shorter length, even while maintaining the same amount of permitted suspension travel.

R>C indicates that piston shock absorber 100 has extendibility travel beyond its compressed length. It should be noted that any piston shock absorber described herein, whether new or prior art, is extendable to an amount that is more than its compressed length. However, piston shock absorber 100 is extendable by an amount that exceeds its compressed length. As used herein, super-extendable denotes extendable by an amount that exceeds the compressed length, so that the extended length is more than double the compressed length.

To more fully appreciate the advantages of new piston shock absorber 100, a prior art piston shock absorber 200, illustrated in FIG. 2, will be described for contrast. FIG. 2 illustrates prior art piston shock absorber 200 in both extended and compressed states. Prior art piston shock absorber 200 comprises piston 201 within an oil-filled cylinder 202. Piston 201 provides shock absorption by moving through the oil in cylinder 202, using a set of orifices and valves that enable oil to pass from one side of piston 201 to the other, and are well-known in the art. Such movement turns mechanical energy into heat energy. Piston 201 is connected by piston rod 203 to mount 204, which connects to part of an automobile suspension.

Prior art piston shock absorber 200 also comprises cylinder wall 206, connected to a second mount 205, which connects to another part of the automobile suspension. Prior art piston shock absorber 200 compresses and extends along an axial direction, where the axis is defined by a line from mount 204, through cylinder 202, to mount 205.

As can be seen in FIG. 2, the extended length, E, is the sum of the length of mount 205, M1; dead space D1, into which piston 201 cannot travel; piston travel distance T; dead space D2; a second piston travel distance T; and the length of mount 204, M2. The compressed length, C, is the sum of mount length M1; dead space D1; piston travel distance T; dead space D2; and mount length M2. Thus, E=M1+M2+D1+D2+2T and C=M1+M2+D1+D2+T. So for prior art piston shock absorber, because E−C=T, it must be that R=T. This means that the amount of compression and extension is limited to the amount of piston travel available to piston 201 within cylinder 202.

Prior art piston shock absorber 200 is described with the following equations: E=C+R; C=E−R; E<2C; C>E/2; R<E/2; and R<C. Although the first two equations, E=C+R and C=E−R, are generic to all piston shock absorbers described herein, the remaining four that are unique to prior art piston shock absorber 200 (E<2C; C>E/2; R<E/2; and R<C) clearly indicate that prior art piston shock absorber 200 cannot be either super-compressible or super-extendable.

Deriving E<2C is simple. Multiplying both sides of (C=M1+M2+D1+D2+T) by 2 gives: 2C=2M1+2M2+2D1+2D2+2T. The terms can be arranged as 2C=(M1+M2+D1+D2+2T)+(M1+M2+D1+D2). But since E=M1+M2+D1+D2+2T, it is clear that 2C=E+(M1+M2+D1+D2) and thus, E=2C−(M1+M2+D1+D2). Since M1, M2, D1 and D2 are all physical distances, (M1+M2+D1+D2)>0, and it must be that E<2C. C>E/2 is a simple derivation from E<2C.

Deriving R<E/2 is also simple. It is obvious from inspection that E=M1+M2+D1+D2+2T, and thus 2T=E−(M1+M2+D1+D2). The requirement that (M1+M2+D1+D2)>0 drives 2T<E, which can be rewritten as R<E/2, because R=T. R<C can be found similarly. The equation C=M1+M2+D1+D2+T is already known from FIG. 2. Because R=T, the prior equation can be rearranged as R=C−(M1+M2+D1+D2). The requirement that (M1+M2+D1+D2)>0 drives R<C.

Examining the four equations that uniquely describe prior art piston shock absorber 200, (E<2C; C>E/2; R<E/2; and R<C), E<2C, indicates that prior art piston shock absorber 200 has an extended length, E, that is less than twice its compressed length, C. The next equation, C>E/2, indicates that prior art piston shock absorber 200 has a compressed length, C, that is greater than half of its extended length, E. This is a significant performance limitation, yet is widespread in automobiles purportedly designed with high-performance suspensions that are intended for use on four wheel drive trails.

R<E/2 indicates that prior art piston shock absorber 200 is compressible by less than half of its extended length. R<C indicates that prior art piston shock absorber 200 is only extendable by less than its compressed length. While it is trivial to note that piston shock absorber 200 is extendable to an amount that is more than its compressed length, it is not extendable by an amount that even matches its compressed length. Therefore, prior art piston shock absorber 200 is neither super-compressible nor super-extendable.

Returning now to FIG. 1, the composition of piston shock absorber 100 will be described, and the derivation of the equations that uniquely describe the clear advantages of piston shock absorber 100 (E>2C; C<E/2; R>E/2; and R>C) will be also be described.

Piston shock absorber 100 comprises a piston 101, within an oil-filled cylinder 102. Piston 101 is connected by piston rod 103 to mount 104, which connects to part of an automobile suspension. Mount 105, however, is not rigidly connected to cylinder wall 106 of cylinder 102. Although piston 101 moves through the oil in cylinder 102 similarly to the way in which piston 201 moves within cylinder 202 in prior art piston shock absorber 200, mount 105 can move along an axial direction relative to cylinder wall 106, where the axis is defined by a line from mount 104, through cylinder 102, to mount 105.

Piston shock absorber 100 further comprises a piston 107, within an oil-filled cylinder 108, having a cylinder wall 109; and a piston 110, within an oil-filled cylinder 111, having a cylinder wall 112. Pistons 107 and 110 are connected to mount 105 through balancing piston rod 113. Balancing piston rod 113 is configured so that force from the center of mount 105, in the direction toward mount 104, is evenly distributed between pistons 107 and 110, at equal lateral distances from piston rod 103. This ensures that there is little to no bending force on piston rods 103 and 113. Pistons 107 and 110, within cylinders 108 and 111 respectively, can operate according to well-known piston shock absorber principles.

Cylinders 102, 108 and 111 are rigidly interleaved, because cylinder 102 is between cylinders 108 and 111, and cylinder wall 106 is immovably connected to cylinder walls 109 and 112. The cylinder walls may be separately constructed and then welded together, or formed out of a single casting. The coupled set of cylinders 102, 108 and 111 form a bank of three cylinders, although more cylinders may be used in alternative embodiments. The bank of cylinders 102, 108 and 111 can be described as oppositely-oriented, because piston 101 moves within cylinder 102 in the opposite direction as pistons 107 and 110 move within cylinders 108 and 111, when piston shock absorber 100 changes from a fully extended configuration to a fully compressed configuration. Piston 101 also moves in an opposite direction as pistons 107 and 110 when piston shock absorber 100 changes from a fully compressed configuration to a fully extended configuration.

If balancing piston rod 113 is centered with respect to piston rod 103, and both cylinders 108 and 111, which house pistons 107 and 111 respectively, offer equal resistance, then piston shock absorber 100 is axially-balanced. That is, there will be minimal bending force, with perhaps some due to imperfect manufacturing tolerances, on piston shock absorber 100. This allows piston shock absorber 100 to compress and extend axially, with pistons 107 and 110 both moving by approximately the same amount during compressions and extensions. This axial balance keeps all of pistons 101, 107 and 110 centered within their respective cylinders, to move with oil-based shock absorption, rather than by friction that would occur between pistons 101, 107 and 110 and the respective one of cylinder walls 106, 109 and 112 if there were a significant bending force.

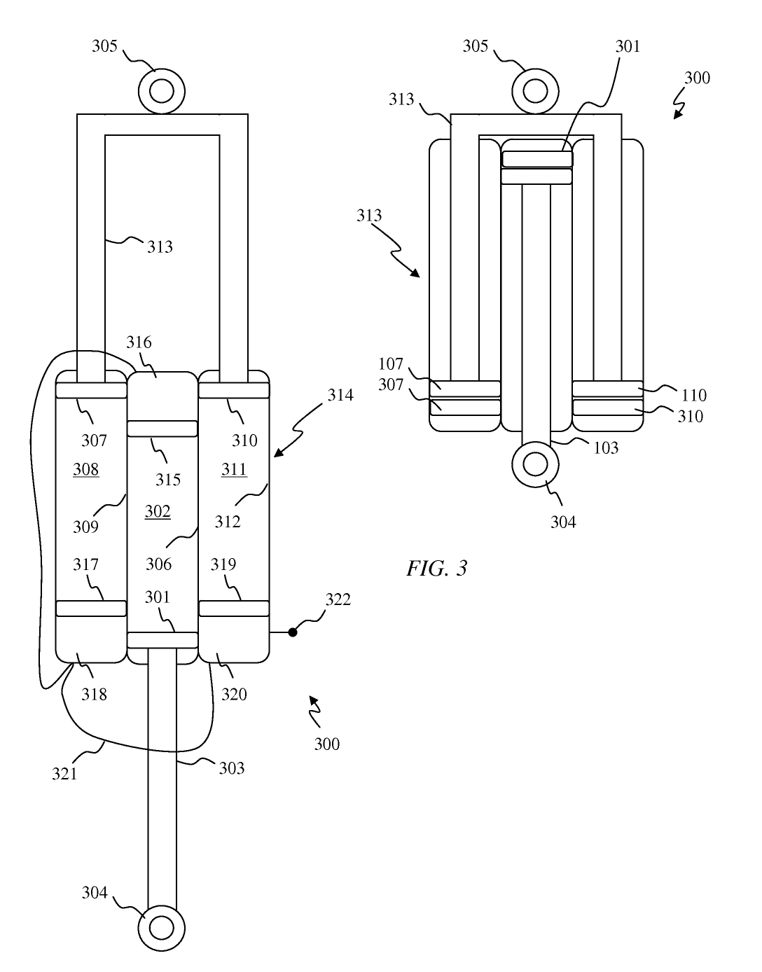

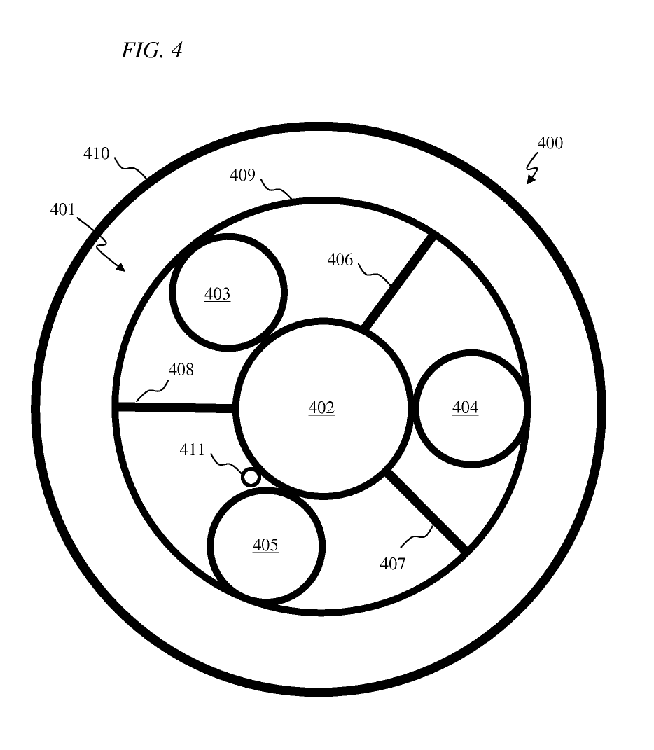

Because the bank of cylinders 102, 108 and 111 can move with respect to both mounting points 104 and 105, when piston shock absorber 100 is installed in an automobile, the bank of cylinders 102, 108 and 111 is free-floating. This can create a number of performance problems, if the design of piston shock absorber 100 is not considered properly. These problems can include excessively asymmetric extension and compression resistance, bending, and cylinder bank sag. Solutions to these problems are presented in the descriptions of FIGS. 3 and 4.

Turning to the derivation of the equations given previously, (E>2C; C<E/2; R>E/2; and R>C), some basic relationships can be identified from simple inspection of FIG. 1: E=M1+M2+D1+D2+3T; and C=M1+M2+D1+D2+T. Using the side-by-side comparison of two identical, stacked and compressed versions of piston shock absorber 100 with another identical, but extended version of piston shock absorber 100, it can be seen that E=2C+S, where S>0 and R=C+S. Here, S is a measure of super-compressibility. A piston shock absorber having S>0 is super-compressible. Any piston shock absorber for which writing the expression E=2C+S requires S<0 is not super-compressible.

To derive E>2C, both sides of (C=M1+M2+D1+D2+T) are multiplied by 2. This gives 2C=2M1+2M2+2D1+2D2+2T, which can be rewritten as 2C=M1+M2+D1+D2+3T+(M1+M2+D1+D2−T). Substituting E gives: 2C=E+(M1+M2+D1+D2−T), and then E=2C−(M1+M2+D1+D2−T). This can be changed to the more useful form of E=2C+(T−(M1+M2+D1+D2)). If (T−(M1+M2+D1+D2))>0, then clearly E>2C. C<E/2 is a simple variation.

(T−(M1+M2+D1+D2)), which equals S, will be greater than 0 if T>(M1+M2+D1+D2), as is illustrated in FIG. 1. So S=T−(M1+M2+D1+D2). Therefore, super-compressibility can be achieved by a travel distance that is greater than the sum of the lengths of both mounts and all dead space. However, even if a piston shock absorber, comprising a rigidly interleaved, oppositely-oriented, free-floating cylinder bank, is not configured such that T>(M1+M2+D1+D2), it will still be far more compressible than prior art shock absorber 200.

To derive R>E/2, E=2C+S is changed to E+S=2C+2S. Because R=C+S, E+S=2R. Therefore, R=E/2+S/2. Since S>0 for piston shock absorber 100, R>E/2. Because E/2>C has already been shown, it is trivial to write R>C. However, a direct derivation of R>C produces some insight. E=M1+M2+D1+D2+3T is changed to: E=M1+M2+D1+D2+T+2T, which can be rewritten as E=C+2T. This becomes E−C=2T and then the intermediate result, R=2T.

This is a significant result. For piston shock absorber 100, the compressibility, R, is twice the piston travel distance, T. That relationship enables super-compressibility to be achieved, when it is coupled with T>(M1+M2+D1+D2).

Work from Here

FIG. 3 illustrates an embodiment of a super-compressible piston shock absorber 300 comprising a rigidly interleaved, oppositely-oriented, free-floating cylinder bank 314 of gas-charged cylinders 302, 308 and 311. Gas charged cylinders are known in the art, and provide outward force on the working pistons 301, 307 and 310.

Piston shock absorber 300 comprises working piston 301, within gas charged cylinder 302 that also houses dividing piston 315. Dividing piston 315 separates the oil-filled region of cylinder 302, in which piston 301 moves, from gas charged region 316. Gas charged region 316 puts an outward force on pistons 315 and also 301, so that piston 301 is pushed toward the opposite end of cylinder 302. Piston 301 is connected by piston rod 303 to mount 304, which connects to part of an automobile suspension.

Piston shock absorber 300 also comprises working piston 307, within gas charged cylinder 308 that also houses dividing piston 317. Dividing piston 317 separates the oil-filled region of cylinder 308, in which piston 307 moves, from gas charged region 318. Gas charged region 318 puts an outward force on pistons 317 and also 307, so that piston 307 is pushed toward the opposite end of cylinder 308. Piston shock absorber 300 further comprises working piston 310, within gas charged cylinder 311 that also houses dividing piston 319. Dividing piston 319 separates the oil-filled region of cylinder 310, in which piston 310 moves, from gas charged region 320. Gas charged region 320 puts an outward force on pistons 319 and also 310, so that piston 310 is pushed toward the opposite end of cylinder 311.

Pistons 307 and 310 are connected to mount 305 through balancing piston rod 313. Balancing piston rod 313 is configured so that force from the center of mount 305, in the direction toward mount 304, is evenly distributed between pistons 307 and 310, at equal radial distances from piston rod 303. This ensures that there is little to no bending force on piston rods 303 and 313. Pistons 301, 307 and 310, within cylinders 302, 308 and 311 respectively, can operate according to well-known piston shock absorber principles. Mount 105 is thus able to move along an axial direction relative to mount 304, where the axis is defined by a line from mount 304, through cylinder bank 314, to mount 305.

Cylinder bank 314 comprises oppositely-oriented cylinders, because piston 301 moves in an opposite direction than pistons 307 and 310 during compression and extension cycles. Cylinder bank 314 is interleaved, because cylinder 302 is placed in the center of cylinder bank 314, between cylinders 308 and 311. The interleaving is rigid, because cylinder walls 306, 309 and 312, of cylinders 302, 308 and 311, respectively, are immovably connected. Cylinder walls 306 may be directly welded to each of cylinder walls 309 and 312 or immovably attached through an intermediate part. Cylinder bank 314 is free-floating, because it can move relative to both mounts 304 and 305. By ensuring equal resistance in both cylinders 308 and 311, along with equal distance of center lines of cylinders 308 and 311 from a centerline of cylinder 302, any compressive force between mounts 304 and 305 will be equally distributed on both sides of cylinder 302. This prevents, to the extent possible with real world manufacturing tolerances, bending forces on cylinder bank 314, making cylinder bank 314 axially balanced.

Piston shock absorber 300 thus comprises a super-compressible piston shock absorber comprising a rigidly interleaved, oppositely-oriented, axially-balanced, free-floating bank of gas-charged cylinders.

With the potential bending problem thus addressed, other engineering challenges remain to be solved: one is the tendency of a free-floating cylinder bank to sag, when the shock absorber is installed vertically. Another is to equalize compression and extension resistances. These three problems, (1) bending, (2) cylinder bank sag and (3) disparate compression and extension resistances, are introduced by the use of a free-floating cylinder bank.

If piston shock absorber 100, as illustrated in FIG. 1, were installed in an automobile vertically, the bank of cylinders 102, 108 and 111 would sag downward, due to the weight of the cylinders 102, 108 and 111 themselves. This is because a pure shock absorber does not support weight, but rather merely dampens motion. This sag would result in piston 101 being further displaced toward a fully compressed state within cylinder 102 than pistons 107 and 110 would be inside cylinders 308 and 311. Thus, during compression cycles, piston 102 could “bottom out” within cylinder 102 while pistons 107 and 110 still had plenty of travel distance remaining. This might be undesirable, although it might be acceptable for some situations.

However, since gas charged cylinder 302 provides an outward force on piston 301, this outward force can provide lift for cylinder bank 314 to counteract the sag, if piston shock absorber 300 were installed with mount 304 in the downward position. Similarly, if piston shock absorber 300 were installed with mount 305 in the downward position, the gas-charged outward forces on pistons 307 and 310 would provide lift for cylinder bank 314. If the outward force on piston 301 is approximately balanced with the outward force on pistons 307 and 310, the forces are significantly greater than the weight of cylinder bank 314, then cylinder bank 314 will remain approximately centered vertically, independent of installation orientation. For a known installation orientation, a slight disparity in outward forces may be used so that the total upward force equals the total downward force, plus the weight of cylinder bank 314. This would more accurately center cylinder bank 314, but likely only for a single compression amount. In some embodiments, a gas pressure equalization tube 321 could link gas charged regions 316, 318 and 320, to balance the charge pressures. Such a pressure link would be desirable for variable-pressure shock absorbers, such as air shocks that have an external pressure valve, such as pressure valve 322.

A method of balancing compression and extension resistance will be presented now, in the description of FIG. 4, which illustrates an axial view of a weight-bearing piston shock absorber 400. Piston shock absorber 400 comprises a free-floating, oppositely-oriented, axially-balanced bank 401 of four cylinders 402, 403, 404 and 405. As illustrated, cylinder 402 is in the center of piston shock absorber, and its center axis, which is centered in the illustrated circle, is also the center axis of the entire assembly. Cylinder 402 is oppositely oriented with respect to the three outer cylinders 403-405. A side view of cylinder 402 and whichever two of cylinders 403-405 were visible (i.e., not obscured behind cylinder 402) would appear similar to one of FIGS. 1 and 3. A balancing piston rod, connecting pistons within cylinders 403-405 would need to have a triangular shape, similar to the shape of the internal portion of the well-known peace sign, branching from the center axis of piston shock absorber 400 to each of the center axes of cylinders 403-405. It should be understood that a different number of outer cylinders could be used, as well as a plurality of smaller inner cylinders.

Structural strengthening members 406-408 connect center cylinder 402 to outer structural member 409. The three outer cylinders 403-405 are also connected to outer structural member 409, which helps to prevent center cylinder 402 from shearing away from the three outer cylinders 403-405. The use of structural strengthening members 406-408 and outer structural member 409 adds weight, and so should be limited to those designs in which cylinders 402-405 might be expected to deform under compression and extension forces. A coil spring 410, shown in an end-on view that renders it as a circle, surrounds cylinder bank 401. The assembly can thus both support weight and provide dampening. Assemblies and mountings of shock absorbers contained within coil springs are known in the art. Gas pressure equalization tube 411, similar to gas pressure equalization tube 321 in FIG. 3, connects the gas charged regions of at least cylinders 403-405, and may also connect to the gas charged region of cylinder 402, to enable both equalization and also pressurization and depressurization of the connected ones of cylinders 402-405.

As illustrated in the axial view of FIG. 4, center cylinder 402 has a larger diameter than outer cylinders 403-405. This illustrates one method of ensuring that the piston assembly within center cylinder 402 compresses and extends at approximately the same rate as the piston assemblies in outer cylinders 403-405. For many current shock absorber cylinder designs, the resistance to compression and extension is approximately proportional to piston surface area. Thus, wide cylinders provide greater movement resistance than narrow cylinders.

If center cylinder 402 offered the same movement resistance as each one of outer cylinders 403-405, then because outer cylinders operate in parallel in the same direction, the collection of outer cylinders 403-405 would provide three times the movement resistance of center cylinder 402. This would cause center cylinder 402 to compress and extend approximately three times as much as the outer cylinders 403-405. Apart from the extra wear on cylinder 402, this causes a potential imbalance in compression and extension resistance. Since cylinder 402 does not provide all of the compression travel, it could bottom out, reaching its fully compressed state, while outer cylinders 403-405 continued to compress. Once cylinder 402 was fully compressed though, any remaining compression must occur only in outer cylinders 403-405. Thus the compression resistance would be three times the compression resistance of cylinder 402. However, upon an extension cycle, cylinder 402 is available to extend. The extension resistance would be slightly lower than the resistance offered by cylinder 402 alone. This extension resistance will be a fraction of compression resistance, and may present undesirable performance characteristics.

One way to analyze the resistance of a set of shock absorbing cylinders is to view them as resisters in an electrical circuit. Shock absorber cylinders that operate in parallel and operate in the same orientation, such that the piston rods move in the same direction when compressing, are equivalent to electrical resisters placed in series. The resistances add. However, oppositely-oriented shock absorber cylinders, for which the piston rods move in opposite directions within a free-floating back of cylinders, are equivalent to electrical resistors placed in parallel.

To balance the resistance of center cylinder 402 with the total resistance of all three surrounding outer cylinders 403-405, the diameter of center cylinder 402 could be approximately sqrt(3) times the diameter of each of cylinders 403-405. Sqrt(3) is approximately 1.73. This cylinder diameter ratio ensures that the surface area of the working piston within cylinder 402 is approximately equal to the total surface area of the working pistons in all of cylinders 403-405. Each of cylinders 403-405 should offer identical compression and extension resistance with each other, within possible manufacturing tolerances, to retain axial balance and prevent bending forces on cylinder bank 401. In general, the ratio of cylinder diameters should be approximately D_up=sqrt(#_down/#_up)×D_down, where #_down and #_up are counts of the numbers of oppositely-oriented cylinders in each indicated direction. Valves and orifices within the working pistons can be tailored to fine-tune the balance of resistance. Thus, piston shock absorber 400 is compression-balanced, because the oppositely-oriented cylinders compress and expand by approximately equal amounts, and center cylinder 402 provides approximately half of the total compression, with outer cylinders 403-405 providing the other half.

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments described in the specification.

What is claimed is:

1. A super-compressible piston shock absorber.

2. A piston shock absorber compressible beyond half its extended length.

3. An apparatus comprising:
a super-compressible piston shock absorber, the super-compressible piston shock absorber comprising:
a rigidly interleaved, oppositely-oriented, axially-balanced, free-floating bank of gas-charged cylinders,
wherein the super-compressible shock absorber is configured to be extendable by an amount that exceeds its compressed length.
